(19) United States
(12) Patent Application Publication
(10) Pub. No.: US 2018/0308456 A1
(43) Pub. Date: Oct. 25, 2018

(54) NON-TRANSITORY COMPUTER-READABLE STORAGE MEDIUM, DISPLAY CONTROL METHOD, AND DISPLAY CONTROL DEVICE

(71) Applicant: FUJITSU LIMITED, Kawasaki-shi (JP)

(72) Inventor: Kyosuke Imamura, Kokubunji (JP)

(73) Assignee: FUJITSU LIMITED, Kawasaki-shi (JP)

(21) Appl. No.: 15/954,731

(22) Filed: Apr. 17, 2018

(30) Foreign Application Priority Data
Apr. 20, 2017 (JP) 2017-083465

(51) Int. Cl. G09G 5/377; G09G 5/00

(52) U.S. Cl. CPC G09G 5/377; G09G 5/006; G06F 3/03545; G09G 2340/12; G09G 2354/00

(57) ABSTRACT

A non-transitory computer-readable storage medium storing a program that causes a computer to execute processing, the processing including identifying display layers of a plurality of display objects displayed in a display area upon a designation operation of the plurality of display objects based on information regarding the display layers of a plurality of display objects, the plurality of display objects being displayed to overlap each other in the display area, and displaying, in the display area, a plurality of operation parts corresponding to a plurality of display objects in accordance with an order of the identified display layers.

### CROSS-REFERENCE TO RELATED APPLICATION

This application is based upon and claims the benefit of priority of the prior Japanese Patent Application No. 2017-83465, filed on Apr. 20, 2017, the entire contents of which are incorporated herein by reference.

### FIELD

The embodiments discussed herein are related to a non-transitory computer-readable storage medium, a display control method, and a display control device.

### BACKGROUND

A technology is known by which a projector installed on the ceiling of a conference room displays or projects (hereinafter simply referred to as displays), for example, an object such as an icon on the surface of a table (for example, see Japanese Laid-open Patent Publication No. 2016-177428). Here, when images are displayed so as to overlap each other on the display surface, an image different from an image to be operated by a user may be selected (for example, see Japanese Laid-open Patent Publication No. 2016-162128).

### SUMMARY

According to an aspect of the invention, a non-transitory computer-readable storage medium storing a program that causes a computer to execute processing, the processing including identifying display layers of a plurality of display objects displayed in a display area upon a designation operation of the plurality of display objects based on information regarding the display layers of a plurality of display objects, the plurality of display objects being displayed to overlap each other in the display area, and displaying, in the display area, a plurality of operation parts corresponding to a plurality of display objects in accordance with an order of the identified display layers.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a display control system;

FIG. 2 is a diagram illustrating an example of a hardware configuration of a server device;

FIG. 3 is a diagram illustrating an example of a functional block diagram of the server device;

FIG. 4 is a diagram illustrating an example of an object information storage unit;

FIG. 5 is a diagram illustrating an example of an operation chip information storage unit;

FIG. 6 is a flowchart illustrating an example of operation of a server device according to a first embodiment;

FIGS. 7A to 7D are diagrams illustrating an operation of a user before operation chips are displayed and an operation of the user after the operation chips have been displayed;

FIG. 8 is a flowchart illustrating an example of operation chip display processing;

FIGS. 9A and 9B are diagrams illustrating display of operation chips;

FIG. 10 is a flowchart illustrating an example of operation of a server device according to a second embodiment;

FIGS. 11A and 11B are diagrams illustrating an example of an operation to change display layers;

FIGS. 12A to 12C are diagrams illustrating an example of an update method;

FIGS. 13A and 13B are diagrams illustrating editing of an object;

FIG. 14 is a diagram illustrating a display name written on an operation chip;

FIGS. 15A to 15C are diagrams illustrating editing of an operation chip;

FIGS. 16A and 16B are diagrams illustrating an example of movement of an object; and

FIGS. 17A and 17B are diagrams illustrating another example of movement of an object.

### DESCRIPTION OF EMBODIMENTS

An object of an embodiment is to provide a non-transitory computer-readable storage medium storing a display control program, a display control method, and a display control device by which the operability of a display object may be improved.

Embodiments of the technology discussed herein are described below with reference to drawings.

### First Embodiment

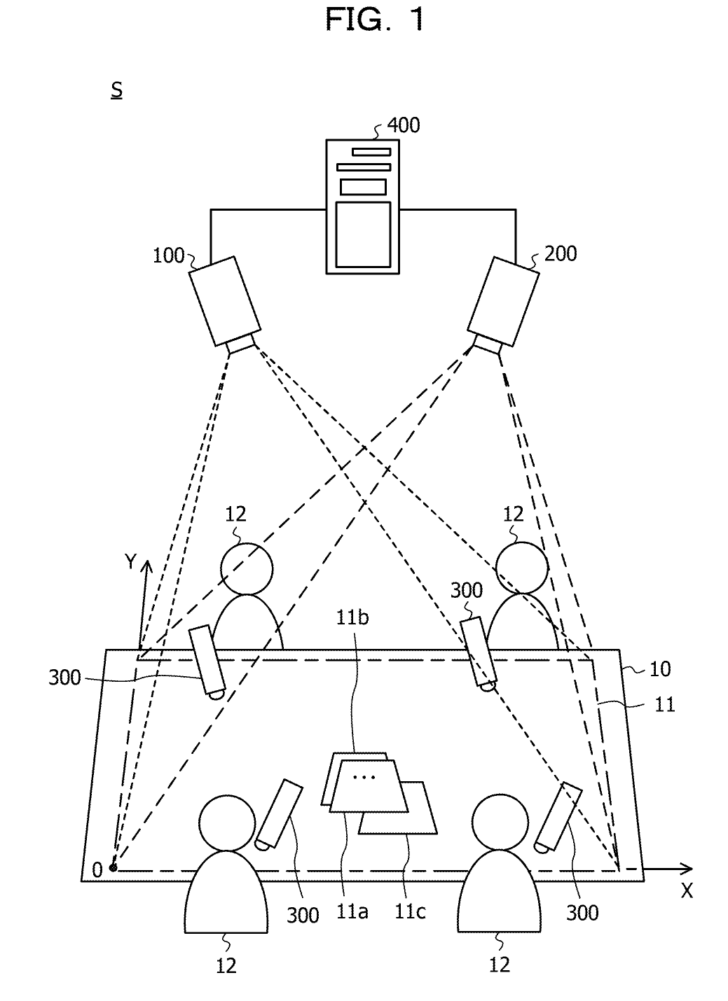

FIG. 1 is a diagram illustrating an example of a display control system S. The display control system S includes a projector 100, a camera 200, an electronic pen 300, and a server device 400. The projector 100, the camera 200, and the server device 400 are coupled to each other through a wire or wirelessly.

The projector 100 displays various objects 11a, 11b, and 11c allowed to be operated in a display area 11 on a table 10. The display area 11 is a displayable area of the projector 100. The display area 11 may be, for example, a wall surface, a screen, or the like. In FIG. 1, the lower left corner of the display area 11 is set as the origin O, and the long-side direction of the table 10 is set as an X axis, and the short-side direction is set as a Y axis, but it is only sufficient that the position of the origin O and the directions of the X axis and the Y axis are set as appropriate.

Here, the objects 11a, 11b, and 11c illustrated in FIG. 1 represent, for example, tags and photos. The objects 11a, 11b, and 11c may represent, for example, graphs, icons, windows, and the like. Each of the objects 11a, 11b, and 11c may be displayed with a size that has been defined in advance or a size that has been specified by a user 12. The projector 100 may display the objects 11a, 11b, and 11c such that the objects 11a, 11b, and 11c overlap each other depending on an operation for the objects 11a, 11b, and 11c by the user 12.

The electronic pen 300 includes a light emitting element that emits infrared rays at the proximal end. The light emitting element emits infrared rays while power is supplied to the electronic pen 300. For example, when the user 12 draws a rectangle in the display area 11 by using the electronic pen 300 that emits infrared rays, the camera 200 captures an image of the infrared shape. For example, when the user 12 moves the object 11a in a specified state by using the electronic pen 300 that emits infrared rays, the camera 200 captures an image of the infrared shape.

The server device 400 controls operation of the projector 100. For example, when the server device 400 accepts the above-described infrared shape from the camera 200, the server device 400 determines the accepted infrared shape, and causes the projector 100 to display the object 11a or to change the display position of the object 11a in accordance with the determination result. As a result, the projector 100 displays the object 11a or displays the object 11a at a position indicating a movement destination of the electronic pen 300.

Even when the above-described objects 11a, 11b, and 11c overlap each other, it is not so difficult to specify one of the objects 11a, 11b, and 11c as long as the degree of overlapping is low, that is, the objects do not overlap each other so much. However, it becomes difficult to specify one of the objects 11a, 11b, and 11c when the degree of overlapping is high, that is, the objects overlap each other significantly, or when the objects completely overlap each other.

For example, when the object 11b is to be moved in a state of being mainly covered by the object 11a, an area used to specify the object 11b is very small, and therefore, an operation to specify the object 11b after the object 11a has been moved is requested. For example, when the object 11c is to be moved in a state of being completely covered by the object 11a and the object 11b, an operation to specify the object 11c after one of the object 11a and the object 11b has been moved is requested.

In such a case, for example, it is also assumed that the server device 400 determines the degree of overlapping between the objects 11a, 11b, and 11c and controls the overlapping degree to be reduced dynamically. However, when the display control system S is used for brainstorming or the like, a similarity between the objects 11a, 11b, and 11c may be represented by a positional relationship between the objects 11a, 11b, and 11c, or an importance degree between the objects 11a, 11b, and 11c may be represented by a hierarchical relationship between the objects 11a, 11b, and 11c. In such a case, it is not desirable that the server device 400 control the overlapping degree to be reduced dynamically. Thus, in the following description, a method is described in which the operability of the objects 11a, 11b, and 11c that overlap each other is improved without a dramatic change in a correlative relationship such as a positional relationship or a hierarchical relationship between the objects 11a, 11b, and 11c.

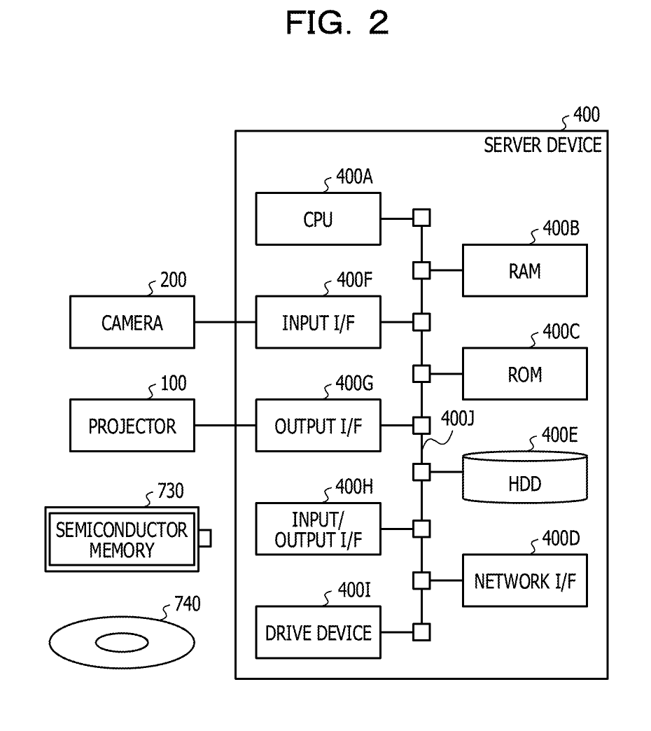

A hardware configuration of the server device 400 is described below with reference to FIG. 2.

FIG. 2 is a diagram illustrating an example of a hardware configuration of the server device 400. As illustrated in FIG. 2, the server device 400 includes at least a central processing unit (CPU) 400A as a processor, a random access memory (RAM) 400B, a read only memory (ROM) 400C, and a network interface (I/F) 400D. The server device 400 may include at least one of a hard disk drive (HDD) 400E, an input I/F 400F, an output I/F 400G, an input/output I/F 400H, and a drive device 4001 as appropriate. These configuration units of the server device 400 are coupled to each other through an internal bus 400J. At least the CPU 400A and the RAM 400B cooperate to realize a computer. Instead of the CPU 200A, a micro processing unit (MPU) may be used as the processor.

The camera 200 is coupled to the input I/F 400F. Examples of the camera 200 include, for example, an infrared camera.

The projector 100 is coupled to the output I/F 400G.

A semiconductor memory 730 is coupled to the input/output I/F 400H. Examples of the semiconductor memory 730 include, for example, a universal serial bus (USB) memory and a flash memory. The input/output I/F 400H reads a program and data stored in the semiconductor memory 730.

Each of the input I/F 400F, the output I/F 400G, and the input/output I/F 400H includes, for example, a USB port.

A portable recording medium 740 is inserted into the drive device 4001. Examples of the portable recording medium 740 include, for example, removable disks such as a compact disc (CD)-ROM and a digital versatile disc (DVD). The drive device 4001 reads a program and data recorded in the portable recording medium 740.

The network I/F 400D includes, for example, a port and a physical layer chip (PHY chip).

A program that has been stored in the ROM 400C or the HDD 400E is stored into the RAM 400B by the CPU 400A. A program that has been recorded to the portable recording medium 740 is stored into the RAM 400B by the CPU 400A. When the CPU 400A executes the stored programs, the server device 400 achieves various functions described later and executes various pieces of processing described later. It is only sufficient that the programs correspond to flowcharts described later.

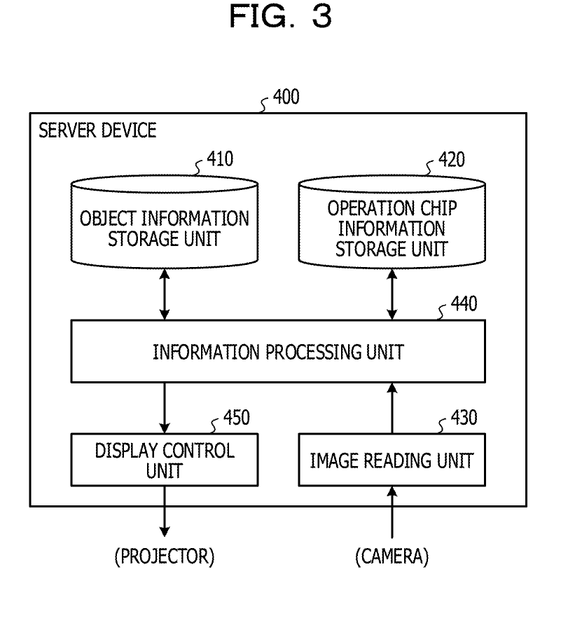

The functions executed or realized by the server device 400 are described below with reference to FIGS. 3 to 5.

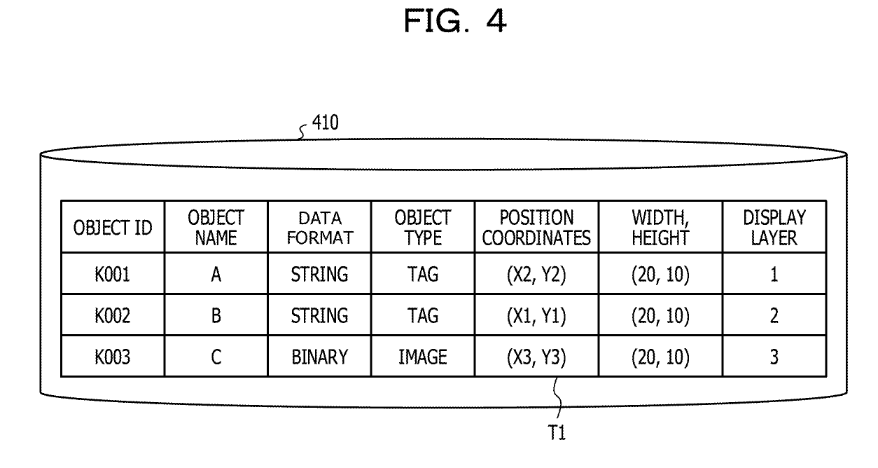

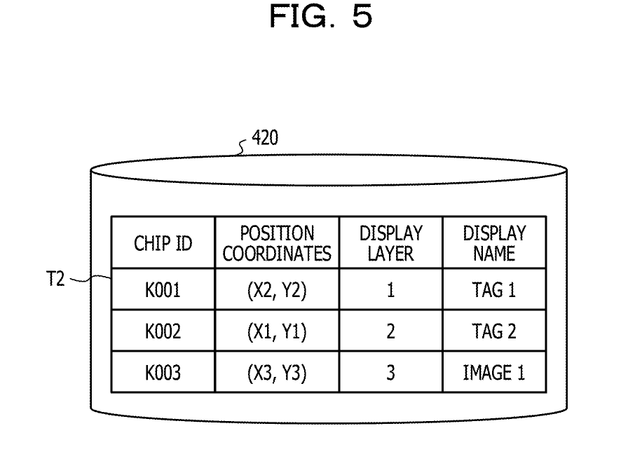

FIG. 3 is a diagram illustrating an example of a functional block diagram of the server device 400. FIG. 4 is a diagram illustrating an example of an object information storage unit 410. FIG. 5 is a diagram illustrating an example of an operation chip information storage unit 420. As illustrated in FIG. 3, the server device 400 includes the object information storage unit 410, the operation chip information storage unit 420, an image reading unit 430, an information processing unit 440 as a processing unit, and a display control unit 450. The information processing unit 440 and at least one of the image reading unit 430 and the display control unit 450 may constitute a processing unit. Each of the object information storage unit 410 and the operation chip information storage unit 420 may be realized, for example, by the above-described RAM 400B, ROM 400C, or HDD 400E. The image reading unit 430, the information processing unit 440, and the display control unit 450 may be realized, for example, by the above-described CPU 400A.

The object information storage unit 410 stores pieces of object information used to respectively identify attributes of the objects 11a, 11b, and 11c. Specifically, as illustrated in FIG. 4, the pieces of object information are managed in an object table T1. The object information includes, as configuration elements, an object ID, an object name, a data format, an object type, position coordinates, a width and a height (referred to as “width, height” in FIG. 4), and a display layer.

The object ID is identification information used to identify object information. The object name is a name of one of the objects 11a, 11b, and 11c. The data format is a data format indicating the object. Examples of the formats of the objects 11a, 11b, and 11c include, for example, a string format and a binary format. The object type indicates a type of the object. For example, when each of the objects 11a and 11b displayed in the display area 11 represents a tag, an object type “tag” is registered in the object information storage unit 410. For example, when the object 11c displayed in the display area 11 represents a photo, a graph, or the like, an object type “image” is registered in the object information storage unit 410. The position coordinates represent an X coordinate and a Y coordinate at a position at which the object is displayed. More specifically, the position coordinates represent the location of one of the four corners of the object (for example, the position at the upper left corner) or an X coordinate and a Y coordinate at the center location between the four corners of the object. The width and the height represent the length in the X axis direction and the length in the Y axis direction of the object. The display layer represents the layer of the object. The display layer “1” represents the top layer, and the display layer represents a lower layer as the value of the display layer increases.

The operation chip information storage unit 420 stores pieces of operation chip information used to respectively identify attributes of operation chips. The operation chip as an operation part is a type of a rectangle object displayed with a size that has been defined in advance in the display area 11 through the projector 100. In addition, the operation chip is an auxiliary object that accompanies each of the objects 11a, 11b, and 11c. In the operation chip, a display name of the object is written as identification information. As illustrated in FIG. 5, the pieces of operation chip information are managed in an operation chip table T2. The operation chip information includes a chip ID, position coordinates, a display layer, and a display name as configuration elements.

The chip ID is identification information used to identify operation chip information. In the chip ID, the same value as the object ID is registered. The position coordinates represent an X coordinate and a Y coordinate at a position at which a corresponding operation chip is displayed. More specifically, the position coordinates represent a location of one of the four corners of the operation chip (for example, the position at the upper left corner) or an X coordinate and a Y coordinate at the center location between the four corners of the operation chip. The display layer represents a display layer corresponding to one of the objects 11a, 11b, and 11c, which has been associated with the operation chip. The display name represents identification information written in the operation chip.

Returning to FIG. 3, the image reading unit 430 periodically reads an infrared ray that has been captured by the camera 200 as a captured image and holds the captured image. The information processing unit 440 obtains the captured image held in the image reading unit 430. After the information processing unit 440 has obtained the captured image, the information processing unit 440 executes various pieces of information processing in accordance with the obtained captured image, and controls operation of the display control unit 450 in accordance with the execution result. For example, when the information processing unit 440 has detected an infrared shape used to select the objects 11a, 11b, and 11c in the captured image, the information processing unit 440 outputs an instruction to change display modes of the objects and an instruction to display corresponding operation chips to the display control unit 450. When the display control unit 450 accepts the instructions that have been output from the information processing unit 440, the display control unit 450 changes the display modes of the objects and causes the projector 100 to display the objects after the change and the corresponding operation chips. That is, the information processing unit 440 displays the objects and the operation chips through the display control unit 450 and the projector 100. Another piece of information processing executed by the information processing unit 440 is described later.

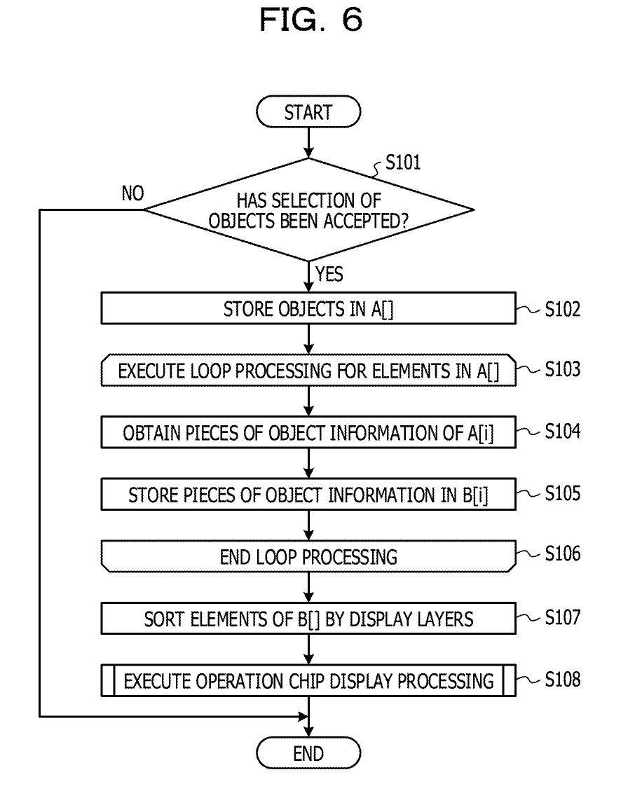

Operation of the server device 400 according to a first embodiment is described below with reference to FIGS. 6 to 9B.

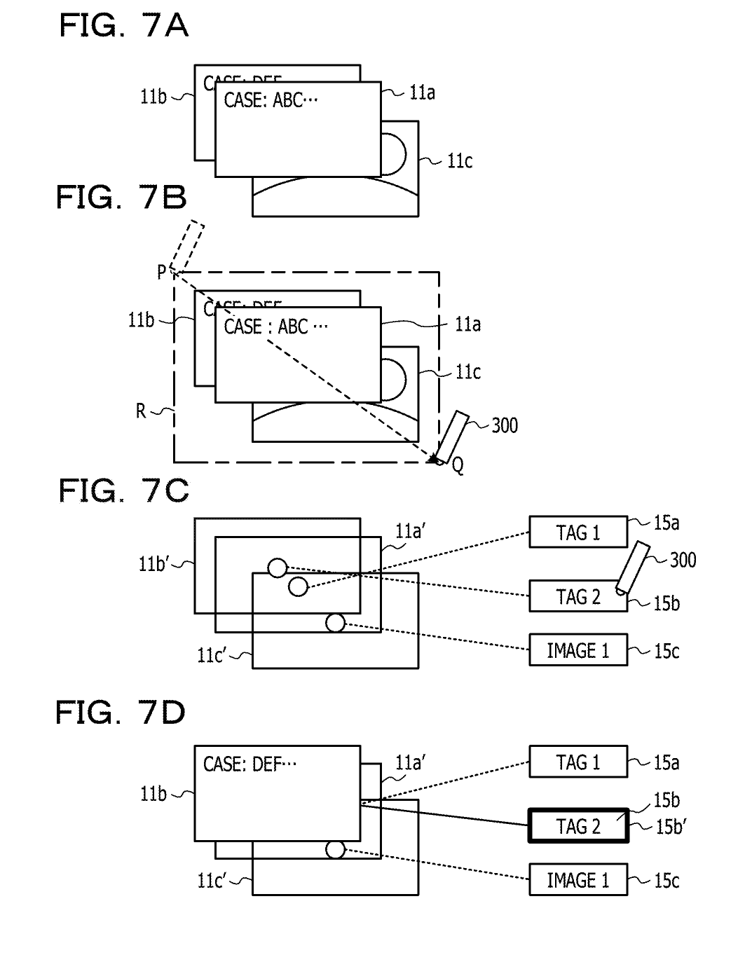

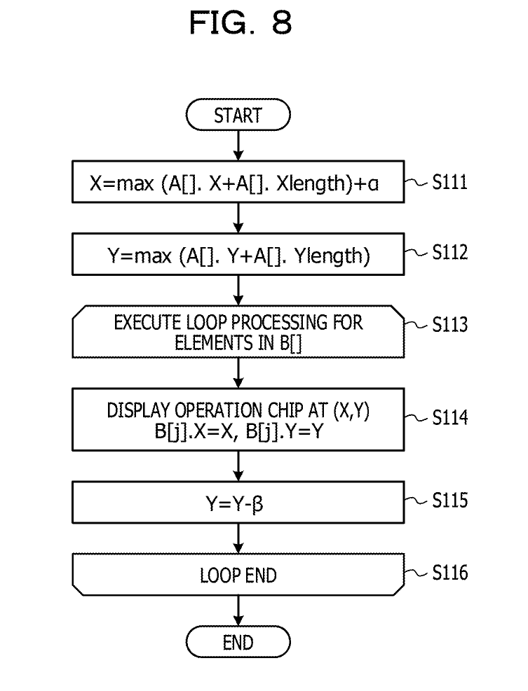

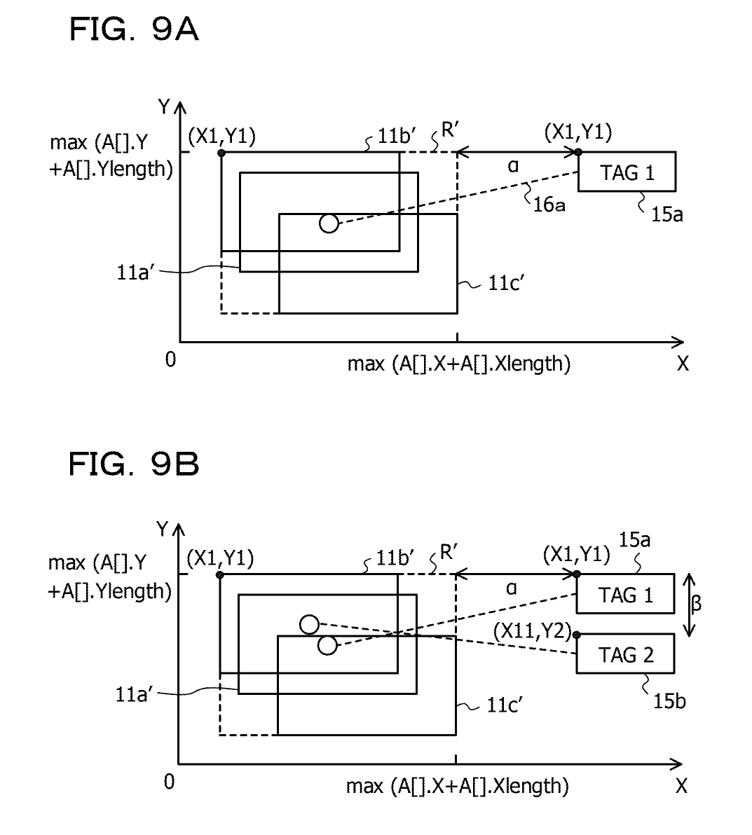

FIG. 6 is a flowchart illustrating an example of the operation of the server device 400 according to the first embodiment. FIGS. 7A to 7D are diagrams illustrating an operation of the user before operation chips 15a, 15b, and 15c are displayed and an operation of the user after the operation chips 15a, 15b, and 15c have been displayed. FIG. 8 is a flowchart illustrating an example of operation chip display processing. FIGS. 9A and B are diagrams illustrating display of the operation chips.

First, as illustrated in FIG. 6, the information processing unit 440 of the server device 400 determines whether selection of the objects 11a, 11b, and 11c has been accepted (Step S101). For example, as illustrated in FIG. 7A, when the objects 11a, 11b, and 11c in the display area 11 are displayed so as to overlap each other, and the electronic pen 300 that emits infrared rays moves from a starting point position P to an ending point position Q as illustrated in FIG. 7B, the information processing unit 440 detects a rectangular region R having a diagonal line from the starting point position P to the ending point position Q, in accordance with the infrared shape. When the objects 11a, 11b, and 11c are included in the detected rectangular region R, the information processing unit 440 determines that selection of the objects 11a, 11b, and 11c in the rectangular region R has been accepted (Step S101: YES).

When the information processing unit 440 determines that selection of the objects 11a, 11b, and 11c has been accepted, the information processing unit 440 outputs an instruction to change the display modes of the objects 11a, 11b, and 11c, to the display control unit 450. As a result, the display control unit 450 changes the display modes of the objects 11a, 11b, and 11c. For example, the display control unit 450 stops display of characters and an image included in each of the objects 11a, 11b, and 11c, and displays the objects 11a, 11b, and 11c in a transmittance state. For example, the display control unit 450 displays frames that define the outlines of the respective objects 11a, 11b, and 11c. As a result, the user 12 may recognize that selection of the objects 11a, 11b, and 11c has been accepted by the server device 400.

When any of the objects 11a, 11b, and 11c is not included in the detected rectangular region R, the information processing unit 440 stops subsequent processing (Step S101: NO). In addition, for example, when the object 11b is partially included in the detected rectangular region R, the information processing unit 440 determines that selection of the object 11b has been accepted. The above-described case for the object 11b is also applied to the objects 11a and 11c.

After the information processing unit 440 has output the instruction to change the display modes, the information processing unit 440 stores the objects 11a, 11b, and 11c in an array A [ ] (Step S102). More specifically, the information processing unit 440 stores the objects 11a, 11b, and 11c in the array A [ ] in selection order. The array A [ ] is an array used to manage the selected objects 11a, 11b, and 11c. For example, as illustrated in FIG. 7B, when the object 11b, the object 11a, and the object 11c have been selected in this order, the information processing unit 440 stores the object 11b, the object 11a, and the object 11c in the array A [ ] in this order.

After the processing of Step S102 has ended, the information processing unit 440 starts loop processing for the elements of the array A [ ] (Step S103). First, the information processing unit 440 obtains object information in the array A [i] (Step S104). More specifically, the information processing unit 440 obtains an object ID and a display layer included in the object information of the array A [i]. Here, “i” is, for example, a counter variable starting from 1. That is, the information processing unit 440 identifies one of the objects 11a, 11b, and 11c, which is the i-th object, as a processing target and obtains object information on the processing target from the object information storage unit 410. For example, as illustrated in FIG. 7B, when the object 11b, the object 11a, and the object 11c have been selected in this order, the information processing unit 440 obtains object information on the object 11b first.

After the processing of Step S104 has ended, the information processing unit 440 stores the pieces of object information in an array B [i] (Step S105). More specifically, the information processing unit 440 stores the object IDs and the display layers that have been obtained in the processing of Step S104 in the array B [i]. The array B [ ] is an array used to manage operation chips.

When the processing of Step S105 ends, the information processing unit 440 ends the loop processing (Step S106). Thus, when there exists a processing target for which the above-described processing of Steps S104 and S105 is yet to be completed, the information processing unit 440 counts up “i” to identify the next processing target and repeats the processing of Steps S104 and S105. As a result, object IDs and display layers of all of the objects 11a, 11b, and 11c are stored in the array B [ ].

After the processing of Step S106 has ended, the information processing unit 440 sorts the elements in the array B [ ] by the display layers (Step S107). For example, when the object 11b, the object 11a, and the object 11c are stored in the array B [ ] in this order, the information processing unit 440 sorts the object 11a, the object 11b, and the object 11c in this order because the object 11b corresponds to a display layer “2”, the object 11a corresponds to a display layer “1”, and the object 11c corresponds to a display layer “3” (see FIG. 4). After the processing of Step S107 has ended, the information processing unit 440 executes operation chip display processing in accordance with the pieces of object information after the sorting (Step S108). The operation chip display processing is processing to display operation chips in the display area 11.

More specifically, as illustrated in FIG. 8, the information processing unit 440 determines a position coordinate X of a first-displayed operation chip to be “X=max(A [ ]·X+A [ ]·X length)+a” (Step S111). After the processing of Step S111 has ended, the information processing unit 440 determines a position coordinate Y of the first-displayed operation chip to be “Y=max(A [ ]·Y+A [ ]·Y length)” (Step S112). The X length and the Y length respectively represent the length in the X axis direction and the length in the Y axis direction of the corresponding object.

For example, as illustrated in FIG. 9A, when frames 11a′, 11b′, and 11c′ of the respective selected objects 11a, 11b, and 11c are displayed, the information processing unit 440 determines the maximum X coordinate from among the X coordinates of the frames 11a′, 11b′, and 11c′ in accordance with the position coordinates and the widths of the objects. In such an embodiment, the information processing unit 440 identifies an X coordinate at the upper right corner or the lower right corner of the frame 11c′ and determines a position away from the identified X coordinate by a specific value α to be an X coordinate of the display position of the operation chip 15a. That is, the specific value α corresponds to a value used to define a minimum rectangular region R′ that encloses the frames 11a′, 11b′, and 11c′ and a margin are for the operation chip 15a. Similarly, the information processing unit 440 determines the maximum Y coordinate from among the Y coordinates of the frames 11′, 11b′, and 11c′ in accordance with the position coordinates and the heights of the objects. In such an embodiment, the information processing unit 440 identifies a Y coordinate of the frame 11b′ and determines a position of the identified Y coordinate to be a Y coordinate of the display position of the operation chip 15a.

After the processing of Step S112 has ended, as illustrated in FIG. 8, the information processing unit 440 starts loop processing for the elements in the array B [ ] (Step S113). First, the information processing unit 440 displays the i-th operation chip at the position coordinates (X,Y) that have been determined in the processing of Step S111 and S112 (Step S114). More specifically, the information processing unit 440 controls the display control unit 450 to cause the projector 100 to display the i-th operation chip such that the upper left corner of the operation chip is matched with the position coordinates (X,Y). As a result, as illustrated in FIG. 9A, the projector 100 displays the operation chip 15a in the display area 11.

The information processing unit 440 displays the operation chip 15a in which a display name used to identify the object 11a is written. The information processing unit 440 determines a display name, for example, in accordance with an object type. In addition, the information processing unit 440 displays the operation chip 15a with a correspondence line 16a by which the object 11a and the operation chip 15a are associated with each other. For example, the information processing unit 440 displays the correspondence line 16a such that one end of the correspondence line 16a is set as the center of the object 11a.

After the processing of Step S114 has ended, the information processing unit 440 determines a position obtained by subtracting “β” from the position coordinate Y to be a new position coordinate Y (Step S115). When the processing of Step S115 ends, the information processing unit 440 ends the loop processing (Step S116). Thus, when there exists a processing target for which the above-described processing of Steps S114 and S115 is yet to be completed, the information processing unit 440 counts up “i” to identify the next processing target and repeats the processing of Steps S114 and S115. As a result, as illustrated in FIG. 9B, the projector 100 displays the operation chip 15b at a position away from the upper left corner of the operation chip 15a in the display area 11 by a specific value β. That is, the specific value β corresponds to a value obtained by adding the length of the margin area between the operation chips 15a and 15b to the length of the operation chip 15a in the Y axis direction. Although the operation chip 15c is not illustrated, by a similar method, the projector 100 displays the operation chip 15c using the operation chip 15b as a reference. When all of the operation chips are displayed, the information processing unit 440 ends the processing.

By the above-described processing, as illustrated in FIG. 7C, in the display area 11, the operation chips 15a, 15b, and 15c that have been associated with the frame 11a′, 11b′, and 11c′ of the respective objects 11a, 11b, and 11c are displayed in order corresponding to the display layers. For example, as illustrated in FIG. 7C, when an operation to specify the operation chip 15b (for example, tap or the like) is performed by the electronic pen 300 that emits infrared rays, the information processing unit 440 detects the specification for the operation chip 15b in accordance with the infrared rays of the electronic pen 300. When the information processing unit 440 detects the specification for the operation chip 15b, as illustrated in FIG. 7D, the information processing unit 440 changes the frame 11b′ that has been associated with the specified operation chip 15b to the object 11b and displays the object 11b. At that time, the information processing unit 440 also change the display mode of the specified operation chip 15b and displays the operation chip 15b the display mode of which has been changed. For example, the information processing unit 440 displays a thick frame 15b′ corresponding to the outline of the specified operation chip 15b or displays the frame 15b′ having the outline the density of which has been darkened.

As described above, even when it is difficult to specify the object 11b because the object 11b is mainly covered by the object 11a, the information processing unit 440 displays the object 11b in a state in which the object 11b is allowed to be operated (hereinafter referred to as an activated state) due to an operation to specify the operation chip 15b, and therefore, the operability of the object 11b may be improved. Similar processing may be applied to even a case in which the object 11b is completely covered by the object 11a.

### Second Embodiment

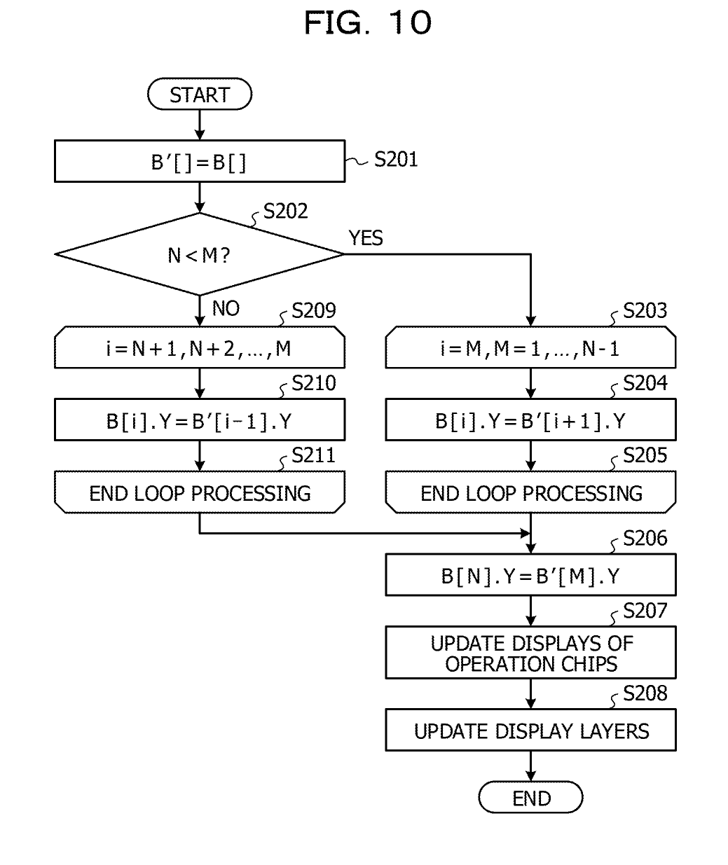

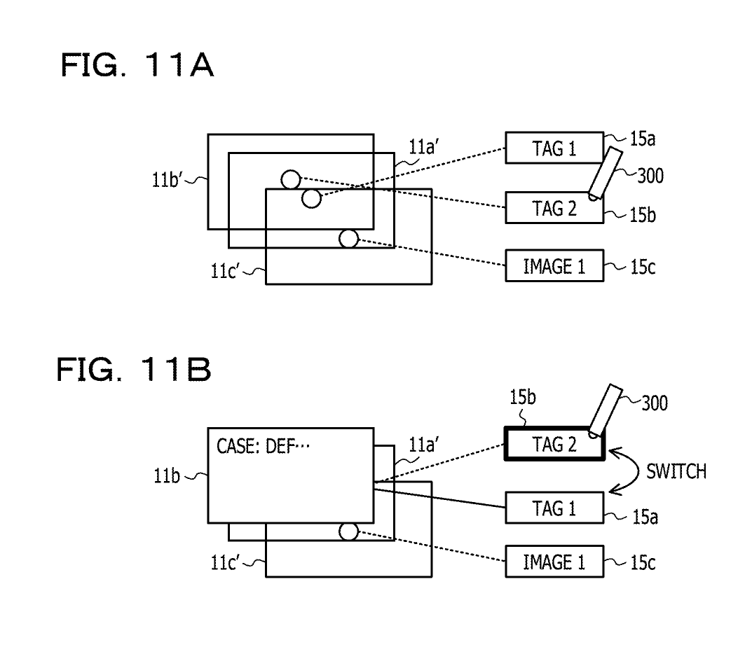

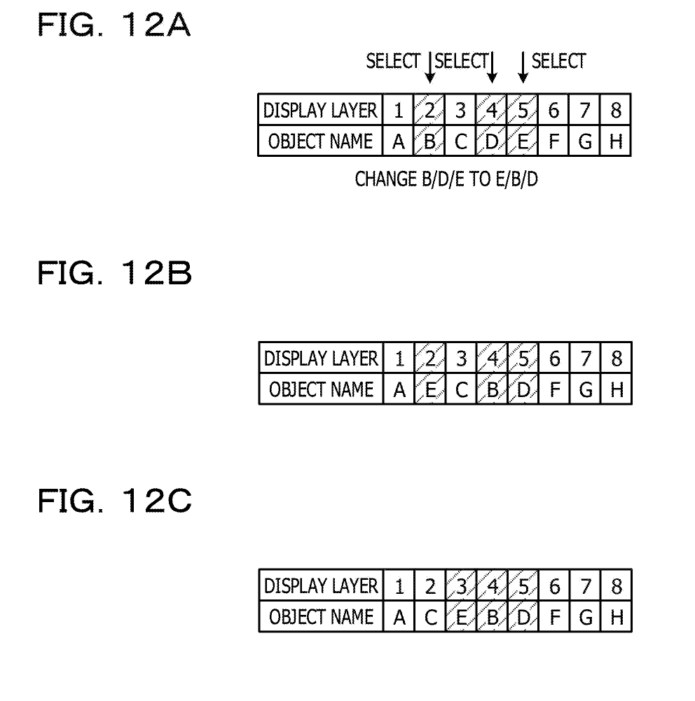

A second embodiment is described below with reference to FIGS. 10 to 12. FIG. 10 is a flowchart illustrating an example of operation of a server device 400 according to the second embodiment. FIGS. 11A and B are diagrams illustrating an example of an operation to change display layers. FIGS. 12A to 12 C are diagrams illustrating an example of an update method.

First, as illustrated in FIG. 10, the information processing unit 440 sets the current array B [ ] to an array B′ [ ] (Step S201). The array B′ [ ] is an array used to manage a change in the display position of an operation chip. For example, as illustrated in FIG. 11A, when the user 12 performs an operation to move the display position of the operation chip 15b in the above-described state illustrated in FIG. 7D to a position above the operation chip 15a by the electronic pen 300 that emits infrared rays, the information processing unit 440 detects an infrared shape of the electronic pen 300 and sets the current array B [ ] to the array B′ [ ].

After the processing of Step S201 has ended, the information processing unit 440 determines the heights of display ranks N and M of the operation chip 15b (Step S202). The display rank N is, for example, a rank of an operation chip before the movement, and the display rank M is, for example, a rank of the operation chip after the movement. In the embodiment, as illustrated in FIG. 11A, the operation chip 15b moves from the position of the display rank “2” to the position of the display rank “1”, such that the information processing unit 440 determines the heights of the display ranks N and M to be 2 and 1, respectively.

When the information processing unit 440 determines that the display rank N is higher than the display rank M for an operation chip (Step S202: NO), the information processing unit 440 sets “M” to “i” and starts loop processing (Step S203). First, the information processing unit 440 sets “array B′ [i+1]·Y” to “array B [i]·Y” (Step S204). In the processing of Step S204, the display position of the operation chip 15a the display rank of which is “1” is changed to the display rank “2”.

When the processing of Step S204 ends, the information processing unit 440 ends the loop processing (Step S205). Thus, the information processing unit 440 counts up “i” to identify the next processing target and repeats the processing of Step S204 when there exists a processing target for which the above-described processing of Step S204 is yet to be completed. In the embodiment, a target the display rank of which is moved down is only the operation chip 15a, such that the information processing unit 440 ends the processing without count-up, but the information processing unit 204 repeats the processing of Step S204, for example, when another operation chip (not illustrated) other than the operation chip 15a is displayed higher than the display rank of the operation chip 15b. As a result, the display rank of the operation chip (not illustrated) is also moved down.

After the processing of Step S205 has ended, the information processing unit 440 sets “B′ [M]·Y” to “array B [N]·Y” (Step S206). In the processing of Step S206, the display position of the operation chip 15b the display rank of which is “2” is changed to the display rank “1”. After the processing of Step S206 has ended, the information processing unit 440 updates the displays of the operation chips 15a and 15b (Step S207). As a result, as illustrated in FIG. 11B, the display position of the operation chip 15a and the display position of the operation chip 15b are switched.

After the processing of Step S207 has ended, the information processing unit 440 updates the display layers (Step S208). More specifically, the information processing unit 440 accesses the operation chip information storage unit 420 to change the display layers of the pieces of operation chip information. In addition, the information processing unit 440 accesses the object information storage unit 410 to change the display layers of the pieces of object information. In the embodiment, the information processing unit 440 changes the display layer “1” of the chip ID “K001” in the operation chip information and the object information to the display layer “2”, and changes the display layer “2” of the chip ID “K002” to the display layer “1”.

In the above-described processing of Step S202, when the information processing unit 440 determines that the display rank N is lower than the display rank M (Step S202: YES), the information processing unit 440 sets “N+1” to “i” starts loop processing (Step S209). For example, when the display position of the operation chip 15a is moved to a position below the display position of the operation chip 15c, the information processing unit 440 determines that the display rank N is lower than the display rank M. In this case, first, the information processing unit 440 sets “array B′ [i−1]·Y” to “array B [i]·Y” (Step S210). In the processing of Step S210, the display position of the operation chip 15b the display rank of which is “2” is changed to the display rank “1”.

When the processing of Step S210 ends, the information processing unit 440 ends the loop processing (Step S211). Thus, when there exists a processing target for which the above-described processing of Step S210 is yet to be completed, the information processing unit 440 counts up “i” to identify the next processing target and repeats the processing of Step S210. As a result, for example, the display rank of the operation chip 15c is moved up. When the processing of Step S211 ends, the information processing unit 440 executes the above-described processing of Steps S206 to S208.

As described above, in the second embodiment, when the user 12 performs an operation to move the display positions of the operation chips 15a, 15b, and 15c by the electronic pen 300, the display layers of the objects 11a, 11b, and 11c that have been associated with the respective operation chips 15a, 15b, and 15c may be changed. Thus, for example, the user 12 may change importance degrees of the objects 11a and 11b each indicating a tag when the user 12 change a hierarchical relationship of the objects 11a and 11b by performing an operation to change the display positions of the operation chips 15a and 15b by the electronic pen 300.

In the second embodiment, the case is descried above in which the objects 11a, 11b, and 11c are selected, and the display positions of the respective operation chips 15a, 15b, and 15c are changed to update the display layers, but various update methods are applied to the update of the display layers. For example, as illustrated in FIG. 12A, a case is described below in which eight objects having respective object names “A” to “H” overlap each other in order of display layers “1” to “8”. When the user 12 selects objects having respective object names “B”, “D”, and “E” and change the display order of the selected objects of the respective object names “B”, “D”, and “E” to order of the object names “E”, “B”, and “D”, the information processing unit 440 may update the display layers in accordance with the original positional relationship between the selected objects. Specifically, as illustrated in FIG. 12B, the information processing unit 440 may update the object having the object name “E” to the display layer “2”, update the object having the object name “B” to the display layer “4”, and update the object having the object name “D” to the display layer “5”.

In addition, the information processing unit 440 may update the display layers so as to bring the selected objects close to the highest ranking object or the lowest ranking object from among the selected objects. Specifically, as illustrated in FIG. 12C, the information processing unit 440 may update the object having the object name “E” to the display layer “3”, update the object having the object name “B” to the display layer “4”, and the object having the object name “D” to the display layer “5”. As described above, the display layers may be updated by various update methods.

### OTHER EMBODIMENTS

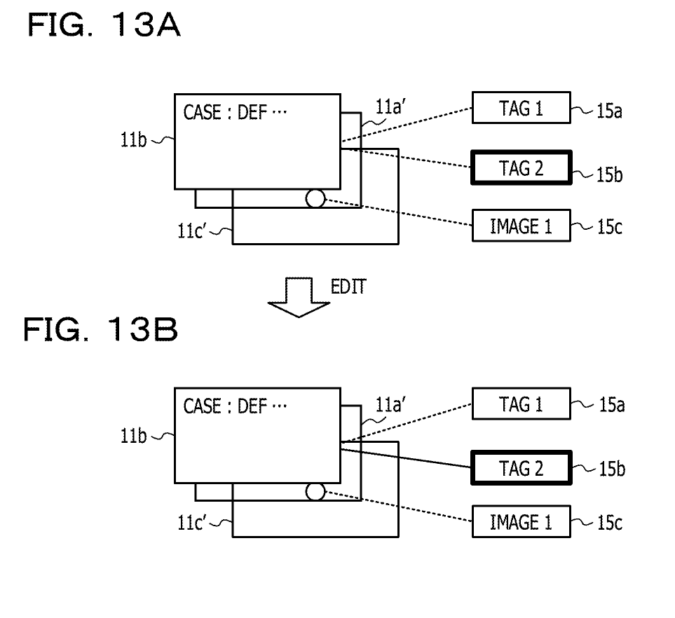

Other embodiments are described below with reference to FIGS. 13A to 17B. FIGS. 13A and 13B are diagrams illustrating editing of the object 11b. As described above with reference to FIG. 7D, when the object 11b is displayed in the state of activation due to the operation to specify the operation chip 15b, the information processing unit 440 controls the object 11b displayed in the state of activation to be allowed to be edited as an editing target. For example, as illustrated in FIG. 13A, when “case: DEF . . . ” is written in the object 11b, the user 12 may edit the described content of the object 11b to “case: PQR . . . ” by using the electronic pen 300 that emits infrared rays, as illustrated in FIG. 13B.

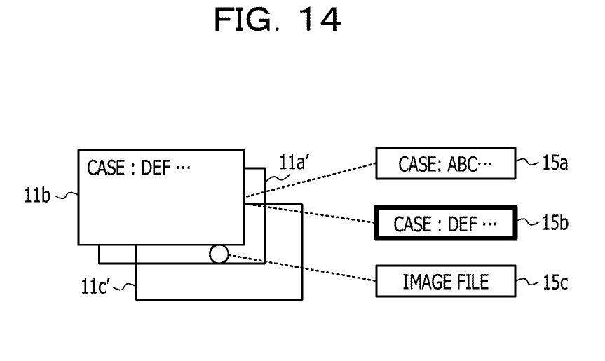

FIG. 14 are diagrams illustrating display names written in the respective operation chips 15a, 15b, and 15c. In the first embodiment, the case is described above in which the information processing unit 440 respectively writes display names that have been determined, for example, in accordance with the object types in the operation chips 15a, 15b, and 15c. For example, as illustrated in FIG. 14, the information processing unit 440 may write the described contents of the objects 11a, 11b, and 11c in the respective operation chips 15a, 15b, and 15c as display names. The information processing unit 440 may write one of configuration elements included in the object information instead of the described content.

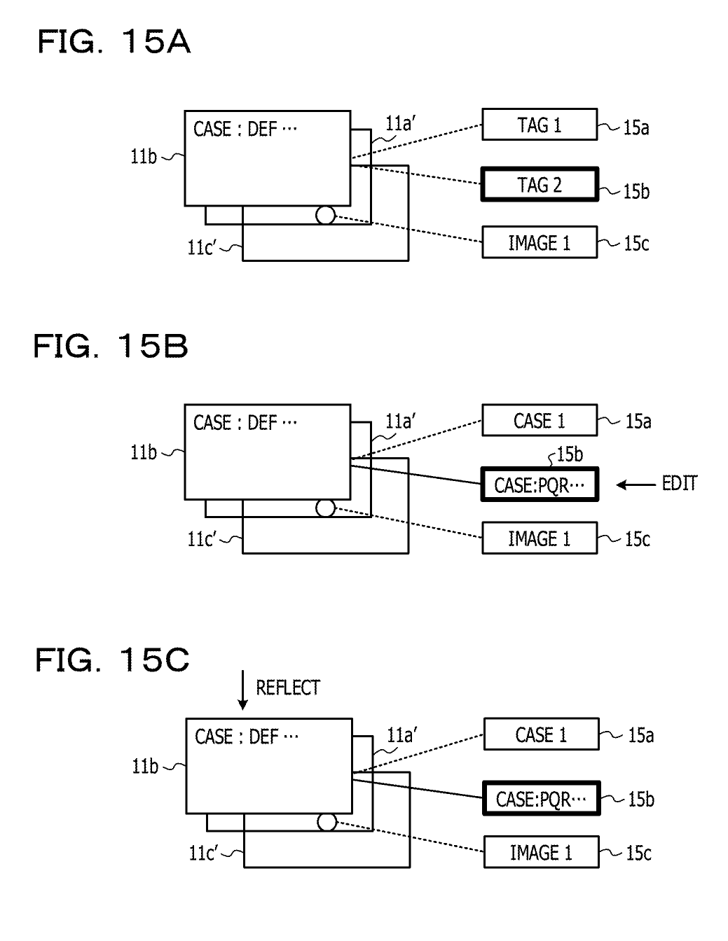

FIGS. 15A to 15C are diagrams illustrating editing of the operation chip 15b. When the user 12 performs an operation to specify the operation chip 15b, the information processing unit 440 controls the specified operation chip 15b to be allowed to be edited. In addition, when the user 12 performs an operation to edit the operation chip 15b, the information processing unit 440 performs control such that an editing content for the operation chip 15b is reflected on the object 11b that has been associated with the operation chip 15b.

Specifically, as illustrated in FIG. 15A, when the user 12 performs an operation to specify the operation chip 15b, “tag 2” written in the specified operation chip 15b become allowed to be edited. As a result, as illustrated in FIG. 15B, the user 12 may edit “tag 2” to “case: PQR . . . ” or the like. When the user 12 ends the operation to edit the operation chip 15b, the information processing unit 440 reflects the editing content for the operation chip 15b on the object 11b that has been associated with the operation chip 15b. As a result, as illustrated in FIG. 15C, “case: PQR . . . ” is reflected on the object 11b.

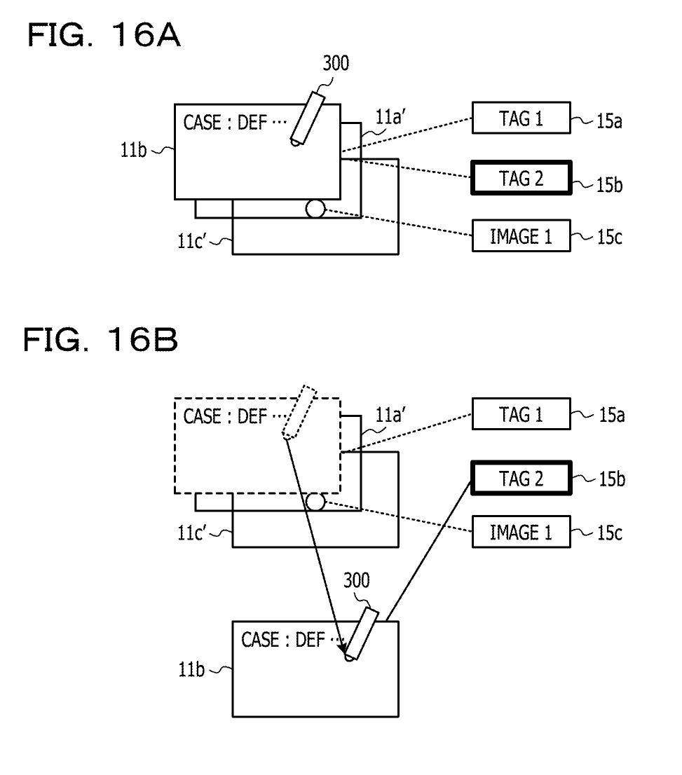

FIGS. 16A and 16B are diagrams illustrating an example of movement of the object 11b. For example, as illustrated in FIG. 16A, when the object 11b displayed in the state of activation is specified as a movement target by the electronic pen 300 that emits infrared rays, the information processing unit 440 controls the specified object 11b to be allowed to be moved. As a result, as illustrated in FIG. 16B, the specified object 11b may be moved.

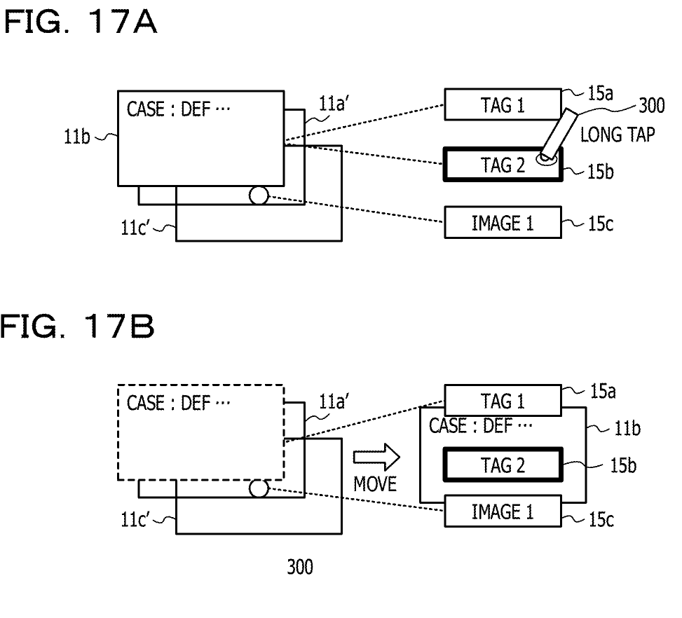

FIGS. 17A and 17B are diagrams illustrating another example of movement of the object 11b. For example, as illustrated in FIG. 17A, when the operation chip 15b is specified by a specific operation (for example, long tap or the like) different from the operation to specify the operation chip 15b by the electronic pen 300 that emits infrared rays, the information processing unit 440 performs control such that the object 11b that has been displayed in the state of activation is drawn to the position that has been specified by the specific operation, as illustrated in FIG. 17B. When the information processing unit 440 determines that the operation chip 15b and the object 11b overlap each other, the information processing unit 440 controls the object 11b to be displayed behind the operation chip 15b.

In addition, although not illustrated, there is a case in which an object smaller than a display object is displayed so as to be hidden behind the display object, in accordance with display ranks that have been specified by respective display layers. In such a case, it is difficult to for the user 12 to perform an operation to directly specify the small object, and therefore, the small object may be overlooked. Thus, when the information processing unit 440 has detected an operation to select the display object displayed so as to cover the small object, the information processing unit 440 may determine that an operation to select the small object with the display object has been performed.

The preferred embodiments of the technology discussed herein are described above, but the technology discussed herein is not limited to the embodiments, and various modifications and changes may be made within the scope of the gist of the technology discussed herein, which is described in the claims. For example, the shape of an operation chip may be defined as appropriate.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium storing a program that causes a computer to execute processing, the processing comprising:
identifying display layers of a plurality of display objects displayed in a display area upon a designation operation of the plurality of display objects based on information regarding the display layers of a plurality of display objects, the plurality of display objects being displayed to overlap each other in the display area; and
displaying, in the display area, a plurality of operation parts corresponding to a plurality of display objects in accordance with an order of the identified display layers.

2. The non-transitory computer-readable storage medium according to claim 1, wherein
the process further comprises:
causing one of the plurality of display objects, corresponding to one of the plurality of operation parts, to be in an editable state or a movable state upon a designation operation of the one of the plurality of operation parts.

3. The non-transitory computer-readable storage medium according to claim 1, wherein
the process further comprises:
switching the order of the identified display layer upon an operation to switch display positions among the plurality of operation parts.

4. The non-transitory computer-readable storage medium according to claim 1, wherein
the plurality of operation parts are displayed at positions corresponding to the positions of the plurality of display objects in the display area.

5. The non-transitory computer-readable storage medium according to claim 1, wherein
the plurality of display objects are designated by specifying a range in the display area, the plurality of display objects being included in the range.

6. The non-transitory computer-readable storage medium according to claim 5, wherein
the plurality of operation parts are displayed at positions corresponding to the range.

7. The non-transitory computer-readable storage medium according to claim 1, wherein
upon an operation to specify a range in the display area, a display of characters or an image contained in the plurality of display objects included in the range is prevented.

8. The non-transitory computer-readable storage medium according to claim 1, wherein
upon an operation to specify a range in the display area, the plurality of display objects included in the range are changed to a plurality of frames that indicates outlines of the plurality of display objects.

9. The display control method executed by a computer, the display control method comprising:
identifying display layers of a plurality of display objects displayed in a display area upon a designation operation of the plurality of display objects based on information regarding the display layers of a plurality of display objects, the plurality of display objects being displayed to overlap each other in the display area; and
displaying, in the display area, a plurality of operation parts corresponding to a plurality of display objects in accordance with an order of the identified display layers.

10. A display control device comprising:
a memory; and
a processor coupled to the memory and the processor configured to execute a process, the process including:
identifying display layers of a plurality of display objects displayed in a display area upon a designation operation of the plurality of display objects based on information regarding the display layers of a plurality of display objects, the plurality of display objects being displayed to overlap each other in the display area; and
displaying, in the display area, a plurality of operation parts corresponding to a plurality of display objects in accordance with an order of the identified display layers.
